(19) United States
(12) Patent Application Publication
(10) Pub. No.: US 2007/0027989 A1
(43) Pub. Date: Feb. 1, 2007

(54) Management of storage resource devices

(75) Inventor: David Austin Gallant, Thornton, CO (US)

Correspondence Address: SHERIDAN ROSS PC, 1560 BROADWAY, SUITE 1200, DENVER, CO, 80202, US

(73) Assignee: Dot Hill Systems Corp.

(21) Appl. No.: 11/195,157

(22) Filed: Aug. 1, 2005

(51) Int. Cl. G06F 15/173

(52) U.S. Cl. 709/226

(57) ABSTRACT

A method and apparatus for managing a community of storage resource devices are provided. Management of each storage resource device within a community may be performed through a connection established between an administrator computer and a proxy storage resource device established over an out-of-band network. The proxy storage resource device may collect information related to other members of the community of storage resource devices, and provide such information to the administrator computer. The administrator computer may also obtain information from, and provide commands to, members of the community of storage resource devices through the proxy storage resource device. Information between members of a community of storage resource devices may exchange information using an in-band network.

### FIELD

The present invention is directed to the management of storage resource devices.

### BACKGROUND

The need to store digital files, documents, pictures, images and other data continues to increase rapidly. In connection with the electronic storage of data, systems incorporating more than one storage device have been devised. In general, using a number of storage devices in a coordinated fashion in order to store data can increase the total storage volume of the system. In addition, data can be distributed across the multiple storage devices such that data will not be irretrievably lost if one of the storage devices (or in some cases more than one storage device) fails. An additional advantage that can be achieved by coordinating the operation of a number of individual storage devices is improved data access and/or storage times.

Storage resource devices are systems that provide at least some integration of individual storage devices, such as JBOD (Just a Bunch of Disks), SBOD (Switched Bunch of Disks) or RAID (Redundant Array of Independent Disks) systems have been developed. Such systems are typically deployed as a number of individual disk drives or other storage devices within an enclosure to present an integrated component to the user. In addition to the individual storage devices, the enclosure may contain one or more power supplies and one or more cooling devices. In addition, integrated storage resource devices may include one or more controllers that can be used to control the distribution of data across the individual storage devices.

In order to permit control and management of integrated storage devices, administrators have been provided with various tools. For example, using host bus adapters connected to integrated storage devices through a Fibre Channel network, information regarding connected devices can be obtained automatically. However, management of integrated storage devices through a Fibre Channel network or other Storage Area Network (SAN) requires specialized host bus adapter drivers. In addition, the storage area network must be properly configured before attempting to configure the attached storage devices. An additional drawback of management of integrated storage devices across a storage area network is that information regarding the network is maintained on an administrator computer that must be connected to the integrated storage devices through the storage area network. Accordingly, remote management of integrated storage devices is difficult or impossible to perform using devices other than the configured network administrator computer.

In order to permit access to the storage resource devices from remote computers, “out of band” solutions have been developed. Such solutions connect a network administrator computer to the storage resource devices through an Internet protocol network, rather than the network used to transfer data between host devices and the storage resource devices, such as Fibre Channel or other storage area networks. Furthermore, such solutions permit control of storage resource devices using an administrator computer running a common web browser. However, management of multiple storage resource devices using such out of band solutions has been problematic. For example, such solutions have been unable to monitor and manage multiple storage resource devices concurrently. In particular, only a single storage resource device can be contacted and administered at a time, because only one IP address, which corresponds to one storage resource device, can be addressed at a time. In addition, the ability to auto-discover attached devices and to obtain other information from a storage area network, such as a Fibre Channel network, is not available to out of band applications, as such applications typically do not have access to (or do not always have access to) an initiator on the storage area network.

### SUMMARY

In accordance with embodiments of the present invention, administration and control of a number of storage resource devices through an administrator computer interconnected to at least one of the storage resource devices through an out of band network is provided. In particular, using a browser running on an administrator computer, and without requiring the use of specialized host software or drivers, an administrator or user can manage a number of storage resource devices by connecting to the IP address associated with one of those devices. More particularly, the one device in communication with the administrator computer serves as a proxy for other storage resource devices. That is, information related to other storage resource devices may be delivered to the administrator computer, or the administrator computer may transmit commands to the other storage resource devices, through the proxy storage resource device.

In accordance with further embodiments of the present invention, a number of storage resource devices are interconnected to one another by a network that is separate from the network interconnecting the proxy storage resource device to the administrator computer. For example, the storage resource devices may be interconnected to one another by a storage area network. The storage resource devices may additionally be interconnected to one another by the network by which the proxy storage resource device is interconnected to the administrator computer. Information identifying the interconnected storage resource devices is exchanged among those devices. As a result, an administrator computer may, in accordance with embodiments of the present invention, establish contact with any one of the storage resource devices to obtain information about any of the storage resource devices.

In accordance with embodiments of the present invention, each storage resource device is aware of every other storage resource device with which it is interconnected. Accordingly, in response to a query or request from an administrator computer, information regarding all of the interconnected storage resource devices can be made available to an administrator. The administrator, through the administrator computer, may create one or more logical groupings or communities of storage resource devices. The administrator may also use the administrator computer to control the storage resource devices. The list of storage resource devices within a community may be stored or maintained on the storage resource device serving as a proxy for that community. In accordance with further embodiments of the present invention, the identities of members of a community may be stored on each storage resource device included in the community. Accordingly, an administrator computer may establish contact with any one storage resource device in a community, thereby nominating the storage resource device to serve as proxy, in order to perform administrative functions with respect to any or all of the members of that community of storage resource devices.

Additional features and advantages of the present invention will become more readily apparent from the following description, particularly when taken together with the accompanying drawings.

### BRIEF DESCRIPTION OF THE DRAWINGS

FIG. 1 is a block diagram of components of a system in accordance with embodiments of the present invention;

FIG. 2 is a block diagram of components of a storage resource device in accordance with embodiments of the present invention;

FIG. 3 is a block diagram of aspects of a controller of a storage resource device in accordance with embodiments of the present invention;

FIG. 4 is a flow chart illustrating aspects of the operation of a storage system in accordance with embodiments of the present invention;

FIG. 5 is a block diagram illustrating communication paths between components of a system in accordance with embodiments of the present invention;

FIG. 6 is a block diagram illustrating other communication paths in accordance with embodiments of the present invention;

FIG. 7 is a block diagram illustrating other communication paths in accordance with embodiments of the present invention; and

FIG. 8 is a screen shot of an administrator user interface in accordance with embodiments of the present invention.

### DETAILED DESCRIPTION

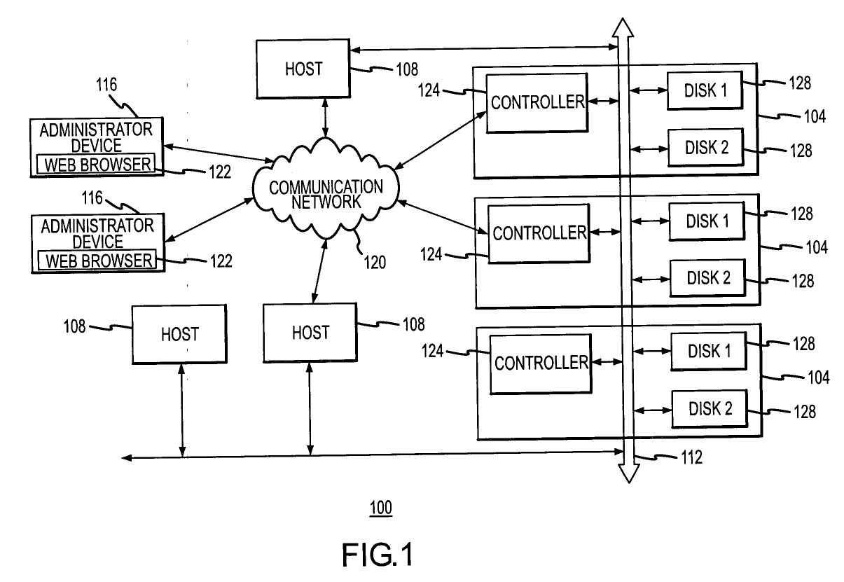

With reference now to FIG. 1, a storage system 100 for permitting the management of multiple storage resource devices through a single storage resource device 104 is illustrated. A storage resource device 104 may generally comprise a means for data storage. The system 100 generally includes a number of storage resource devices 104 interconnected to one or more host processors or computers 108 by an in-band network 112. A host computer 108 generally comprises a means for sending and/or receiving data. In addition, the system 100 generally includes one or more administrator computers 116 interconnected to at least one of the storage resource devices 104 through a communication or out-of-band network 120. Each administrator computer 116 may include or be associated with a web browser application 122 to facilitate communications over the out-of-band network 120. Together, an administrator computer 116 and associated web browser 122 generally comprise a means for administering. One or more of the host devices 108 may also be interconnected to one or more of the storage resource devices 104 and/or to one or more administrator computers 116 through the out-of-band network 120.

In accordance with embodiments of the present invention, a storage resource device 104 may comprise a controller 124 and one or more data storage devices 128. In general, a controller 124 controls the data storage and retrieval of data to or from the storage devices 128. In addition, the controller 124 may perform other functions, such as parity checking and error correction. Furthermore, a controller 124 in accordance with embodiments of the present invention may operate to provide and/or collect information related to storage resource devices 104 other than the storage resource device 104 with which the controller 124 is associated, and to receive and/or execute commands in association with its storage resource device or other storage resource devices 104, as described herein. As can be appreciated by one of skill in the art, a controller 124 may be implemented in connection with one or more digital signal processors executing instructions stored as firmware or software.

The in-band or storage area network 112 generally functions to transport data between storage resource devices 104 and host devices 108, and can be any data pipe capable of supporting multiple initiators and targets. Accordingly, examples of in-band networks 112 include Fibre Channel (FC), iSCSI, parallel SCSI, Ethernet, ESCON, or FICON connections or networks, which may typically be characterized by an ability to transfer relatively large amounts of data at medium to high bandwidths. The out-of-band network 120 generally functions to support the transfer of communications and/or commands between various network nodes, such as storage resource devices 104, host devices 108, and/or administrator computers 116, although data may also be transferred over the in-band communication network 120. Examples of an out-of-band communication network 120 include a local area network (LAN) or other transmission control protocol/Internet protocol (TCP/IP) network. In general, the out-of-band communication network 120 is characterized by an ability to interconnect disparate nodes or other devices through uniform user interfaces, such as a web browser. Furthermore, the out-of-band communication network may provide the potential for globally distributed management, or even management of systems that include components that are in near-Earth orbit.

As shown in FIG. 1, every node computer or device 104, 108 and 116, need not be interconnected to every other node or device through both the in-band network 112 and the out-of-band network 120. In general, only one storage resource device 104 needs to be interconnected to the out-of-band communication network 120 to permit communications with an administrator computer 116. As a further example, none of the host devices 108 needs to be interconnected to any other host device 108, storage resource device 104, or administrator computer 116 through the out-of-band communication network 120, although interconnections between a host device 108 and other devices 104, 108, 116 through the out-of-band communication network 120 are not prohibited. Furthermore, an administrator computer 116 is generally interconnected to at least one storage resource device 104 through the out-of-band communication network 120. An administrator computer 116 may also be interconnected to the in-band network 112 directly, although such an interconnection is not required. Instead, an administrator computer 116 is typically interconnected to the in-band network 112 through a controller 124 of a storage resource device 104, as described herein.

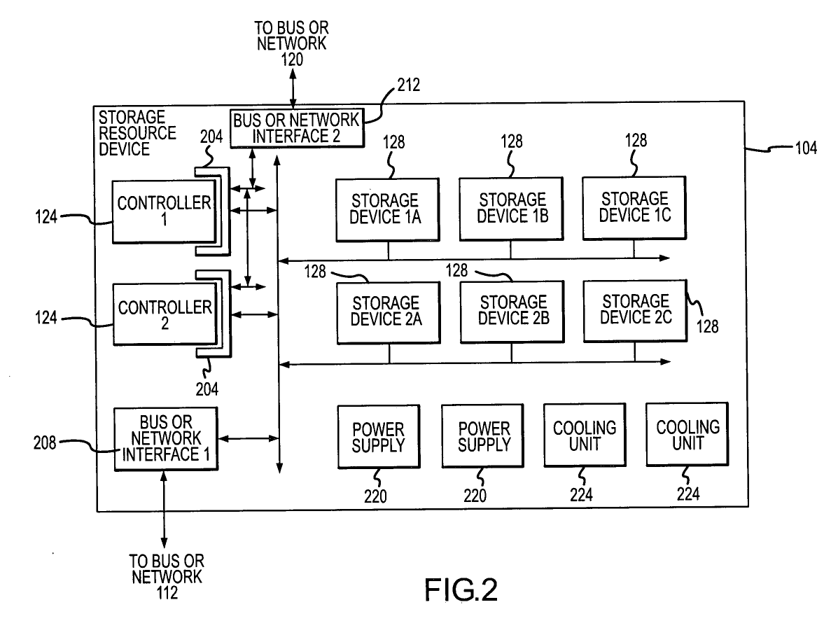

With reference now to FIG. 2, components of a storage resource device 104 in accordance with embodiments of the present invention are illustrated. As shown in FIG. 2, a storage resource device 104 may include one or more controllers 124. As can be appreciated by one of skill in the art, providing multiple controllers 124 is often desirable in order to provide redundancy, and therefore provide improved fault tolerance and data availability. In addition, providing multiple controllers 124 can improve data throughput. As also illustrated in FIG. 2, controllers 124 may be provided as field replaceable units that are received by corresponding slots 204 when installed in a storage resource device 104.

The storage resource device 104 also generally includes at least a first bus or network interface 208 to operatively interconnect components of the storage resource device 104 to the in-band network 112. In addition, a second bus or network interface 212 may be provided to interconnect components of a storage resource device 104 to the out-of-band communication network 120. In general, at least one storage resource device 104 included in a storage system 100 in accordance with embodiments of the present invention is interconnected to the out-of-band communication network 120 through a second bus or network interface 212.

A storage resource device 104 may include a number of data storage devices 128. If multiple data storage devices 128 are provided, they may be grouped in various coordinated ways, for example to provide redundancy, and/or to provide improved data throughput as compared to an uncoordinated grouping of data storage devices 128. Examples of different data storage devices 128 that may be included in a storage resource device 104 include hard disk drives, such as Fibre Channel (FC) hard disk drives. Other examples of data storage devices that may be used in connection with embodiments of the present invention include serial advanced technology attachment (SATA) disk drives and small computer systems interface (SCSI) disk drives. Embodiments of the present invention may also utilize data storage devices 128 other than devices utilizing magnetic disks as a storage medium. For example, a data storage device 128 may also include magnetic tape, optical storage devices or solid-state disk devices.

One or more power supplies 220 may be included to provide power in the form required by the other components of the storage resource device 104. For example, a power supply 220 may convert 120-volt line power to a 12-volt direct current for supply to the data storage devices 128, and a 3-volt direct current for supply to the controller or controllers 124. One or more cooling units 224 may also be provided to help insure that the nominal operating temperatures of data storage devices 128 and other components included in the storage resource device 104 are not exceeded. In accordance with embodiments of the present invention, a cooling unit 224 may comprise a fan or blower powered by an electric motor for moving air through an enclosure housing the storage resource device 104. Furthermore, although shown as separate from the power supplies 220, a cooling unit 224 may be integrated with a power supply 220. Other examples of cooling units 224 include systems that incorporate a liquid cooling medium.

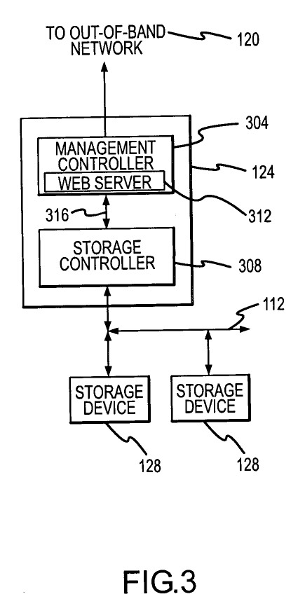

With reference now to FIG. 3, components of a controller 124 in accordance with embodiments of the present invention are illustrated. In particular, a controller 124 having a management controller 304 and a storage controller 308 that is at least logically separate from the management controller 304 is illustrated. That is, the management controller 304 and storage controller may be implemented with common (i.e., the same) hardware running separate management controller 304 and storage controller 308 threads. In accordance with other embodiments of the present invention, the management controller 304 and the storage controller 308 may be implemented using physically separate processors, or by a combination of shared and separate processors. In general, the management controller 304 performs functions associated with the administration of a storage resource device 104. Accordingly, the management controller 304 may incorporate or operate in association with a web server 312 that provides an interface to a web browser running on an administrator computer 116. Such a management controller 304 may therefore be connected to the out-of-band communication network 120. In addition, the management controller 304 may perform functions associated with the collection and maintenance of information related to the identity and operation of storage resource devices 104 other than the storage resource device 104 with which the management controller 304 is a part of, as described in greater detail elsewhere herein. The management controller 304 may also permit an administrator to control aspects of the operation of the storage resource device 104 of which the management controller 304 is a part.

The storage controller 308 generally functions to control the storage and retrieval of information to and from data storage devices 128. Accordingly, the storage controller 308 receives data from host devices 108 via the in-band network 112 for storage on the data storage devices 128. Accordingly, the storage controller 308 may function to perform parity operations and the distribution of data across multiple storage devices 128. The storage controller 308 also generally functions to retrieve data from data storage devices 128 on the associated storage resource device 104, perform error checking and/or correction, and deliver retrieved data to a requesting host device 108 via the in-band network 112.

As also illustrated in FIG. 3, a communication link 316 may be provided for communications between the management controller 304 and the storage controller 308. In accordance with embodiments of the present invention, data transferred by the communication link 316 may include commands and information related to the identities of other storage resource devices 104 in a storage system 100. In addition, the communication link 316 may transmit instructions received at the management controller 304 from a network administrator computer 116 connected to the management controller 304 by the out-of-band network 120 that are intended for other storage resource devices 104. Furthermore, such instructions may be passed by the storage controller 308 via the in-band network 112 to such other storage resource devices 104. That is, the storage controller 308 may be used by the management controller 304, or by an administrator computer 116 interconnected to the management controller 304 by the out-of-band network 120, as an initiator on the in-band network 112.

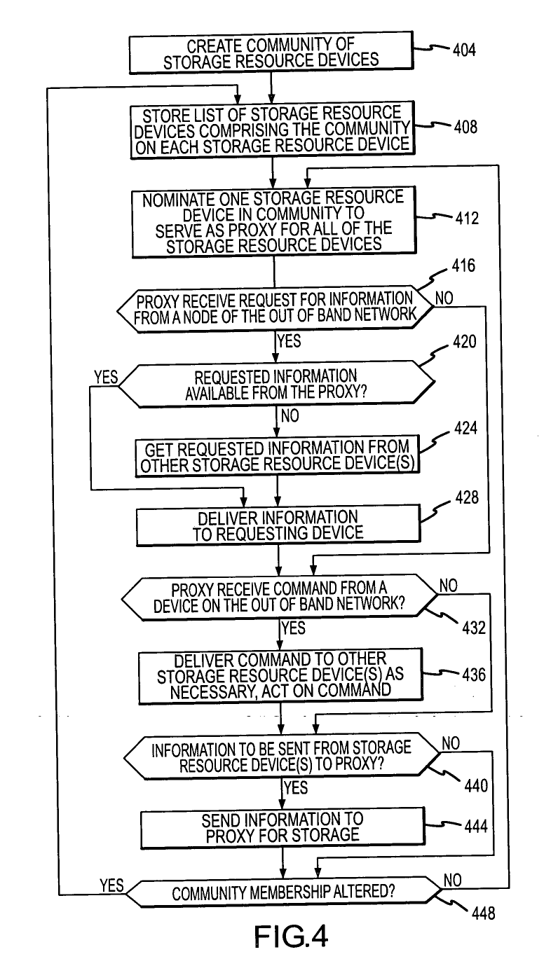

With reference now to FIG. 4, aspects of the operation of a storage system 100 in accordance with embodiments of the present invention are illustrated. At step 404, a community of storage resource devices 104 is created. The creation of a community of storage resource devices 104 may comprise interconnecting a number of storage resource devices 104 to one another using an in-band network 112, to create a storage area network. As can be appreciated by one of skill in the art, the storage resource devices 104 may automatically discover one another. Such auto discovery may be performed in accordance with the protocol of the in-band network 112. Furthermore, auto discovery may be performed as storage resource devices 104 are added to the in-band network 112, or as the storage resource devices 104 are powered on. Accordingly, each storage resource device 104 interconnected to an in-band network 112 may, through auto discovery, obtain a list of other storage resource devices 104 on the same in-band network 112. This list, representing the community of storage resource devices, may then be stored on each storage resource device 104 (step 408).

One of the storage resource devices 104 in the community may then be nominated to serve as a proxy for all of the storage resource devices 104 in that community (step 412). The nomination of a storage resource device 104 to act as a proxy device can comprise addressing one of the storage resource devices 104 in the community using an administrator computer 116 interconnected to that storage resource device 104 by the out-of-band network 120. That is, a proxy may be nominated by establishing a connection with the proxy storage resource device 104 and performing operations concerning other storage resource devices 104 in the community. Such operations may include, for example, requesting information regarding the identity of other storage resource devices 104, requesting information related to the status of other storage resource devices 104, and delivering commands to other storage resource devices 104. Accordingly, it can be appreciated that information regarding storage resource devices 104 other than the proxy storage resource device 104, and/or commands can be delivered to storage resource devices 104 other than the proxy storage resource device 104, via a connection between an administrator computer 116 and the proxy storage resource device 104 established over the out-of-band network 120. More particularly, an administrator may access a community of storage resource devices 104 by establishing a connection with one of the community members. For example, using an out-of-band network 120 comprising a TCP/IP network, an administrator computer 116 can connect to a community of storage resource devices 104 through a connection established with a proxy storage resource device 104 established using the IP address of the proxy storage resource device 104. In addition, the identity of the proxy storage resource device 104 can change, depending on the storage resource device 104 that the administrator computer 116 has contacted.

A determination may then be made as to whether a proxy has received a request for information from a node of the out-of-band network 120 (step 416). For example, a proxy storage resource device 104 may receive a request for information from an administrator computer 116, a host device 108, or a device operating as both an administrator and a host device. If a request for information has been received, a determination may then be made as to whether the information requested is available from the proxy storage resource device 104 (step 420). Examples of the type of information that may be requested of a proxy storage resource device 104 include information identifying other storage resource devices 104 in the community of interconnected storage resource devices, any logical groupings of the community of storage resource devices 104 that have been defined, the operating status of the storage resource devices 104 in the community or configuration data specific to a particular community member. If the requested information is not available from the proxy storage resource device 104, the requested information is obtained from other storage resource devices 104 in the community (step 424), if such other information is available. For example, information related to the identification of members within a community of storage resource devices 104 is typically maintained on each member storage resource device 104, and therefore available from the proxy storage resource device 104. Other information regarding the community of storage resource devices 104 may also be stored on each storage resource device 104. For information not maintained on the storage resource device 104 nominated as a proxy by being contacted by a device through the out-of-band network 120, such information can be obtained through and inter-device query transmitted over the in-band network 112 to the storage resource device 104 to which the requested information pertains, or to another storage resource device 104 that has or is to believed to have the requested information. In accordance with still other embodiments of the present invention, information may be retrieved from other storage resource devices 104 by the proxy storage resource device 104 over the out-of-band network 120, or over a combination of the out-of-band 120 and in-band 112 networks. After getting the requested information from another storage resource device 104, or after determining that the proxy storage resource device 104 already has the requested information, that information is delivered to the requesting device 108, 116 across the out-of-band network 120 (step 428).

At step 432, a determination may be made as to whether a command has been received from a device on the out-of-band network 120. For example, a command related to the logical grouping of storage resource devices 104 within the community may be received. As a further example, commands to some or all storage resource devices within a community may be provided with a particular operating parameter value. If the proxy storage resource device 104 has received a command from a device on the out-of-band network 120, the command is delivered to other of the storage resource devices 104 interconnected to the proxy storage resource device 104 as necessary, and the storage resource devices 104 to which the command is directed may then act on that command (step 436).

After determining that the proxy has not received a command, or after delivering and acting on a command, a determination may be made as to whether information is to be sent from a storage resource device or devices 104 to the proxy storage resource device 104 (step 440). If information is to be sent, then it is delivered to the proxy information storage device for storage (step 444). For example, a change in status, a change in configuration, or a status update may be provided from a storage resource device 104 within a community of storage resource devices 104 to a proxy storage resource device 104. Alternatively, each storage resource device 104 within a community may store information related to other storage resource devices 104.

After determining that there is no information to be sent from a storage resource device 104 to the proxy storage resource device 104, or after sending such information, a determination may be made as to whether the membership of the community of storage resource devices 104 has been altered (step 448). For example, a storage resource device 104 may be added to or removed from a community of storage resource devices 104. If the membership of the community of storage resource devices 104 has been altered, the process may return to step 408, and an updated list of storage resource devices 104 comprising the community may be stored on each of the storage resource devices 104 that are members of the community. If it is determined that the membership of the community of storage resource devices 104 has not been altered, the process may return to step 412.

As can be appreciated by one of skill in the art from the description provided herein, the aspects of the operation of a storage system 100 described in connection with FIG. 4 are related to the administration of a community of storage resource devices 104 from a device interconnected to at least one of the storage resource devices 104 within the community through a connection established across an out-of-band network 120. Furthermore, although such aspects of the operation of the storage system 100 are presented in a sequence, some or all of the described steps may be performed continuously and/or simultaneously.

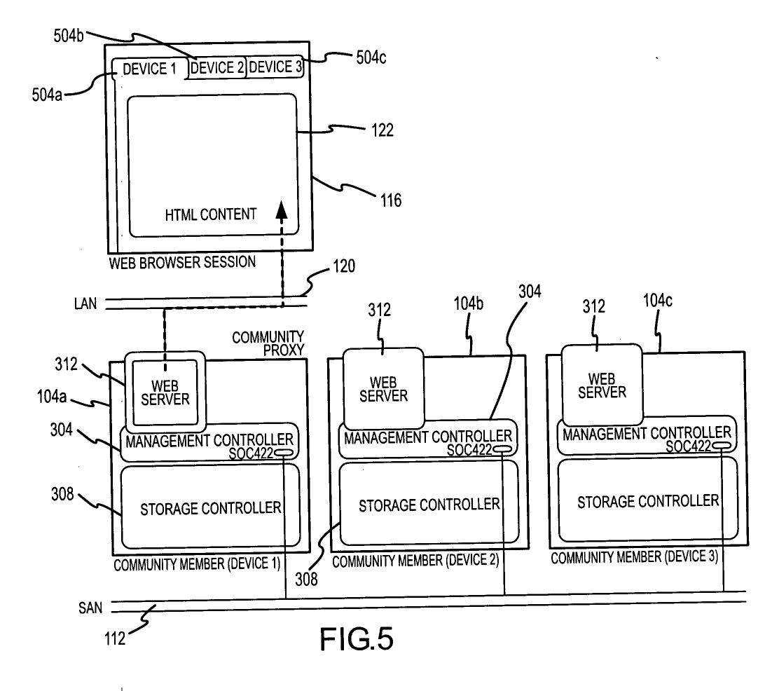

With reference now to FIG. 5, exemplary communication paths between components of a storage system 100 in accordance with embodiments of the present invention are illustrated. In particular, an administrator computer 116 is shown interconnected to a single storage resource device 104a using a connection established over an out-of-band network 120 comprising a local area network. More particularly, the administrator computer 116 is illustrated running a web browser application 122 that interacts with and is provided content from a web server 312 running on the proxy storage resource device 104a.

Information may be transferred or exchanged between the members 104a-c of the community of storage resource devices 104a-c across the in-band network 116. In the example of FIG. 5, the in-band network 112 comprises a storage area network. Furthermore, the communication path may be established between the management controller 304 running on each storage resource device 104, via the storage controller 308 of the associated storage resource device 104.

As shown in FIG. 5, the web browser running on the administrator computer 116 may access information related to each of the three storage resource devices 104 included in the community, by clicking on a tab 504 associated with a particular storage resource device. In particular, the web browser 122 is depicted as if the first tab 504a, related to the first (proxy) storage resource device 104a were selected to display information related to that device. In order to access information related to the second 104b or third 104c storage resource device, an administrator may click on the second 504b or third 504c tabs respectively. In accordance with embodiments of the present invention, information related to the other storage resource devices 104b and 104c in the community may be obtained through the connection with the first storage resource device 104a nominated as a proxy using the out-of-band network 120. Furthermore, such information may be passed from the other storage resource devices 104b and 104c to the proxy storage resource device 104a across the in-band network 112. Furthermore, although the provision of information (and receipt of commands) related to a storage resource device 104 may be the responsibility of the management controller 304, the management controller 304 may use the storage controller 308 as an initiator on the in-band network 112, to transmit (or receive) information between the associated storage resource device 104b or 104c and the proxy storage resource device 104a. Accordingly, it can further be appreciated that a user of the administrator computer 116 need only establish a connection with the proxy storage resource device 104a over the out-of-band network 120 in order to receive information (or provide information or commands) to each storage resource device 104a through 104c included in the community.

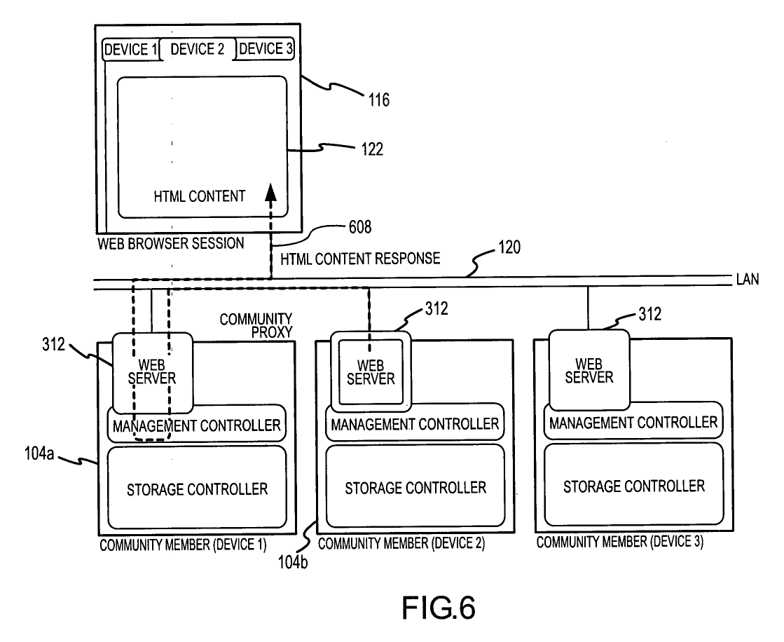

With reference now to FIG. 6, an arrangement of communications between storage resource devices 104a through 104c within a community in accordance with other embodiments of the present invention are illustrated. In particular, the administrator computer 116 is shown as running a browser application 122 that is interconnected to and in communication with a web server 312 running on a proxy storage resource device 104a over an out-of-band network 120 comprising a local area network. In addition, the web browser is shown as displaying information related to the second storage resource device 104b included in the community. Furthermore, as represented by the dotted line 608, the communication path used to deliver information related to the second storage resource device 104b is established over the out-of-band network 120, and passes through the proxy storage resource device 104a, to a web server 312 on the second storage resource device 104b. Accordingly, even though each storage resource device 104a-c within the community is interconnected to the out-of-band network 120, an administrator may receive information related to each of the storage resource devices 104a through establishing a connection with the proxy storage resource device 104a. Accordingly, an administrator need only have knowledge of the IP address of a single storage resource device 104 within the community in order to obtain information from or provide information or commands to, any storage resource device 104 within the community.

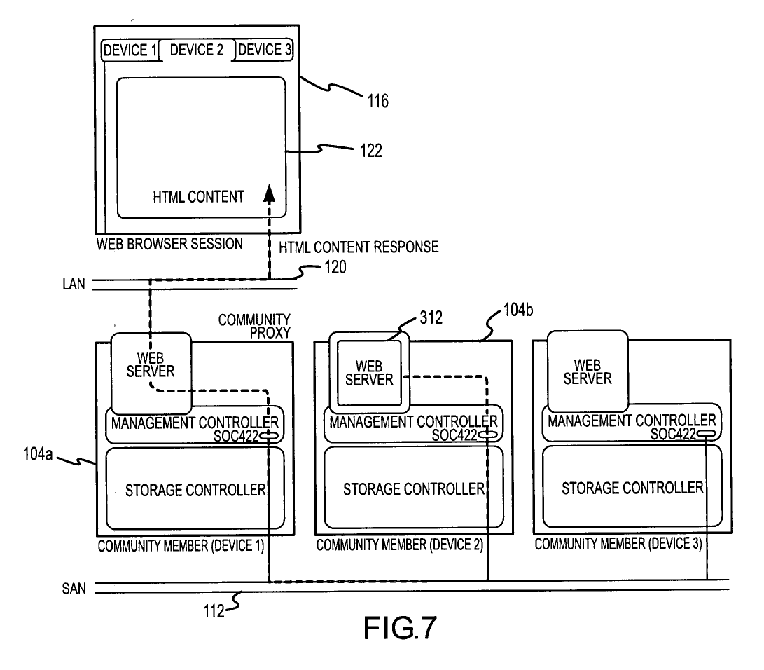

With reference now to FIG. 7, an example of communication paths that may be established in connection with still other embodiments of the present invention are illustrated. In particular, an administrator computer 116 is shown with a web browser 122 receiving content from a web server 312 running on a second storage resource device 104b. Furthermore, the web server 312 on the second storage resource device 104b is interconnected to the web browser via a path that is established between the administrator computer 116 and the first or proxy storage resource device 104a over the out-of-band network 120, and between the first storage resource device 104a and the second storage resource device 104b over the in-band network 112. Accordingly, FIG. 7 is an illustration of obtaining information related to a member of a community of storage resource devices 104 by connecting to a proxy storage resource device 104a, which communicates with the members of the community via the in-band network 112.

Although various combinations and examples of communication paths are illustrated and described, it should be appreciated that other arrangements can be established in accordance with embodiments of the present invention. In particular, embodiments of the present invention may include any arrangement in which a connection between a proxy storage resource device 104 and an administrator computer 116 (or a host device 108 operating as an administrator computer 116) is established over an out-of-band network 120 and in which the connection between the proxy storage resource device 104 and the administrator computer 116 is used to transfer information related to or intended for a storage resource device 104 other than the proxy storage resource device 104.

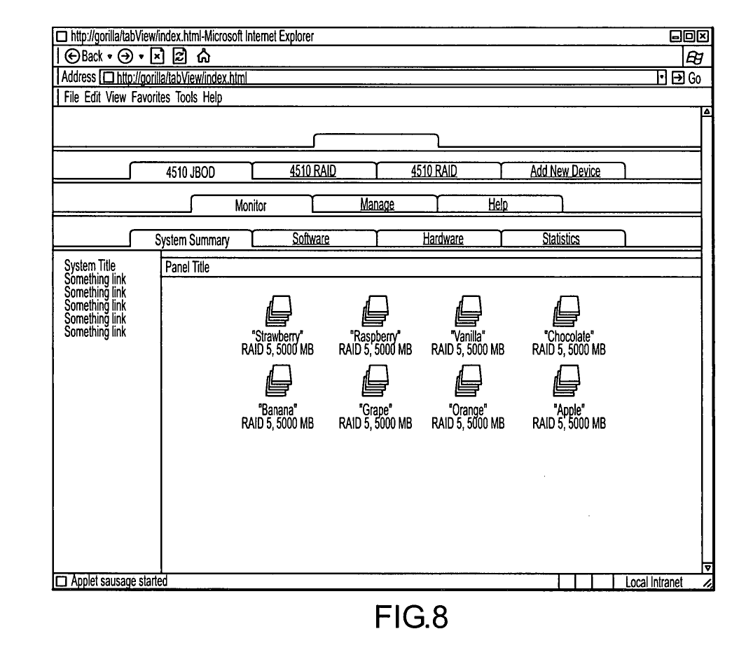

With reference now to FIG. 8, a screen shot of an example web browser display in accordance with embodiments of the present invention is illustrated. In particular, the screen shot provides an example of the information that may be obtained regarding the members of a community of storage resource devices 104 through a connection established between an administrator computer 116 and a proxy storage resource device 104 included in the community. As also illustrated, various information may be organized using tabs, to facilitate access to desired information by an administrator.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described herein above are further intended to explain the best mode presently known of practicing the invention and to enable others skilled in the art to utilize the invention in such or in other embodiments and with the various modifications required by their particular application or use of the invention. It is intended that the appended claims be construed to include alternative embodiments to the extent permitted by the prior art.

What is claimed is:

1. A method for managing a number of storage resource devices, comprising:
interconnecting a number of storage resource devices to one another to form a community of said storage resource devices;
exchanging information of a first type between said interconnected storage resource devices, wherein said information of said first type includes identification information related to said interconnected storage devices;
nominating a first storage resource device included in said number of interconnected storage resource devices to serve as a proxy; and
providing from said first storage resource device to a first administrator computer at least some of said first information.

2. The method of claim 1, further comprising:
receiving at said first storage resource device a request for information from said first administrator computer related to a second storage resource device.

3. The method of claim 2, further comprising:
said first storage resource device responding to said request for information by forwarding said request for information to said second storage resource device, receiving said requested information from said second storage resource device, and providing said requested information related to said second storage resource device to said first administrator computer.

4. The method of claim 1, further comprising:
said first storage resource device maintaining a list of said interconnected storage devices comprising said community.

5. The method of claim 1, further comprising maintaining on each of said interconnected storage resource devices a list including each of said other interconnected storage resource devices included in said community.

6. The method of claim 1, further comprising:
maintaining a list on each of said interconnected storage resource devices of a subset of said storage resource devices included in said community, wherein a selection of said subset of storage resource devices is received by said proxy storage resource device from said first administrator computer.

7. The method of claim 1, further comprising:
interconnecting an additional storage resource device to said number of interconnected storage devices;
after said interconnecting an additional storage resource device, exchanging said information of said first type between said interconnected storage resource devices, wherein said information of said first type includes identification information related to said interconnected storage devices.

8. The method of claim 1, wherein said first administrator computer is interconnected to said first storage resource device by a first network, said method further comprising:
receiving data for storage from a second network at any one of said storage resource devices included in said community.

9. The method of claim 8, wherein said first and second storage resource devices are interconnected to one another by said second network and are not interconnected to one another by said first network.

10. The method of claim 8, wherein said first network comprises an Internet Protocol network, and wherein said first administrator computer is interconnected to said first storage resource device using an Internet Protocol address of said first storage resource device.

11. The method of claim 10, further comprising:
interconnecting said first administrator computer to said second storage resource device using an Internet Protocol address of said second storage resource device;
receiving at said second storage resource device a request for information related to any storage resource device included in said community;
said second storage resource device responding to said request for information by providing said requested information to said first administrator computer.

12. The method of claim 10, further comprising:
interconnecting a second administrator computer to said first storage resource device using said Internet Protocol address of said first storage resource device;
receiving at said first storage resource device a request for information related to any storage resource device included in said community;
said first storage resource device responding to said request for information by providing said requested information to said second administrator computer.

13. The method of claim 8, wherein said second network comprises one of a Fibre Channel network, an iSCSI network, an Ethernet Network or an SCSI bus, and wherein said first network is not an iSCSI network.

14. A storage system, comprising:
a number of storage resource devices, each including:
at least one storage device;
at least one controller, wherein said controller maintains a list of all other storage resource devices in a storage resource device community;
a first network, wherein any one of said storage resource devices within said storage resource device community is in communication with at least one of: 1) any other of said other storage resource devices in said storage resource device community; and 2) a host over said first network.

15. The system of claim 14, wherein one of said storage resource devices is a proxy storage resource device, and wherein said proxy is in communication with said host over said first network.

16. The system of claim 15, further comprising:
a second network, wherein for each of said storage resource devices said at least one storage device is in communication with at least one controller over said second network.

17. The system of claim 16, wherein said controller of at least one of said storage resource devices further includes:
a management controller interconnected to said first network; and
a storage controller interconnected to said second network.

18. The system of claim 17, wherein said proxy includes a management controller, and wherein said management controller of said proxy storage resource device is interconnected to said second network through said storage controller of said proxy storage resource device.

19. The system of claim 17, wherein said management controller and said storage controller of at least one of said number of storage resource devices are implemented in connection with a shared processor.

20. The system of claim 16, wherein at least one of said storage resource devices comprises a number of storage devices.

21. The system of claim 16, wherein said second network interconnects said proxy storage resource device to at least one other of said number of storage resource devices.

22. A data storage system, comprising:
first network means for interconnecting computer devices;
second network means for interconnecting computer devices;
a plurality of means for data storage interconnected to one another by at least said second network means;
means for administering said means for distributed data storage, wherein said means for administering is interconnected to at least one of said means for distributed data storage by said first network means, wherein information related to any of said plurality of means for distributed data storage is obtained by said means for administering by requesting said information from one of said means for distributed data storage; and
means for sending or receiving data, wherein said means for sending or receiving data is interconnected to said means for distributed data storage by said second network means.

23. The system of claim 22, wherein at least one of said plurality of means for distributed data storage is interconnected to other of said means for distributed data storage through said second network means only.

24. The system of claim 22, wherein each of said plurality of means for distributed data storage includes:
means for storing data;
means for controlling a distribution of data on said means for storing data.

25. The system of claim 24, wherein each of said plurality of means for distributed data storage further includes:
means for managing information related said means for distributed data storage, wherein said means for managing information maintains a list identifying each of said means for distributed data storage interconnected to one another.
